(19) United States
(12) Patent Application Publication
(10) Pub. No.: US 2007/0240813 A1
(43) Pub. Date: Oct. 18, 2007

(54) Process for forming a multilayer film and the film formed therefrom

(76) Inventors: Yu Hu, Evansville, IN (US); Nitin Vaish, Evansville, IN (US); Kevin Patrick Capaldo, Mount Vernon, IN (US); Chunghei Yeung, Evansville, IN (US)

Correspondence Address: CANTOR COLBURN, LLP, 55 GRIFFIN ROAD SOUTH, BLOOMFIELD, CT, 06002, US

(21) Appl. No.: 11/405,084

(22) Filed: Apr. 17, 2006

(51) Int. Cl. B29C 47/00

(52) U.S. Cl. 156/244.11; 264/173.16

(57) ABSTRACT

In one embodiment, the process for forming a multilayer film comprises disposing a supportive layer adjacent to an imprinting layer to form a multilayer film and imprinting microstructures in the imprinting layer as the multilayer film passes between a heated roller and a compression roller. The multilayer film is free of a removable carrier layer. The supportive layer has a supportive layer glass transition temperature that is greater than or equal to about 15° C. higher than the imprinting layer glass transition temperature and/or the supportive layer has a supportive layer melting temperature that is greater than or equal to about 15° C. higher than an imprinting layer melting temperature. The imprinting temperature is lower than the supportive layer melting temperature.

### BACKGROUND

Disclosed herein are processes for forming a multilayer film and the films formed thereby.

Embossing processes have been utilized to provide surface structures in a film. For example, embossing processes have been utilized to provide film surface structures that include angled, cubic patterns to direct, diffuse, or polarize light. Films with these surface structures are used in backlight displays, signs, microfluidic devices, electronic devices, and elsewhere.

Current embossing processes utilize a separate carrier layer to support the film during the embossing process. Basically, the film is disposed onto the carrier layer. The film, which is at a temperature above its glass transition temperature, is forced against a pattern (e.g., embossing belt or embossing drum), which comprises surface features that are a negative image of the features desired. As the heated film is forced against the pattern, the film flows into the surface features. The film is then cooled below its glass transition temperature to freeze the positive of the surface features into the film, and removed from the pattern. The film must then be stripped from the carrier layer. Removal of the carrier layer, however, may damage the surface features on the film.

There is a continual need for more efficient processes and systems for embossing films.

### BRIEF DESCRIPTION OF THE INVENTION

Disclosed herein are processes for forming a multilayer film and the films formed thereby.

In one embodiment, the process for forming a multilayer film comprises disposing a supportive layer adjacent to an imprinting layer and imprinting microstructures in the imprinting layer as the multilayer film passes between a heated roller and a compression roller, wherein the imprinting layer has an imprinting temperature that is lower than the supportive layer melting temperature. During processing, the multilayer film is free of a removable carrier layer. The supportive layer has a supportive layer glass transition temperature that is greater than or equal to about 15° C. higher than the imprinting layer glass transition temperature and/or the supportive layer has a supportive layer melting temperature that is greater than or equal to about 15° C. higher than an imprinting layer melting temperature.

In another embodiment, the process for forming a multilayer film comprises: heating an imprinting layer to an imprinting layer temperature and imprinting microstructures in the imprinting layer to form a multilayer film comprising the imprinting layer and a supportive layer. The supportive layer physically contacts the compression roller during processing. The supportive layer has a supportive layer glass transition temperature that is greater than or equal to about 15° C. higher than the imprinting layer glass transition temperature and/or the supportive layer has a supportive layer melting temperature that is greater than or equal to about 15° C. higher than an imprinting layer melting temperature.

The above described and other features are exemplified by the following figures and detailed description.

### BRIEF DESCRIPTION OF THE DRAWINGS

Referring now to the figures, which are exemplary embodiments, and wherein the like elements are numbered alike:

FIG. 1 is schematic illustration of a system for embossing a multilayer film; and

FIG. 2 is a side view illustration of the multilayer film, rollers and an embossing belt of the system of FIG. 1.

### DETAILED DESCRIPTION

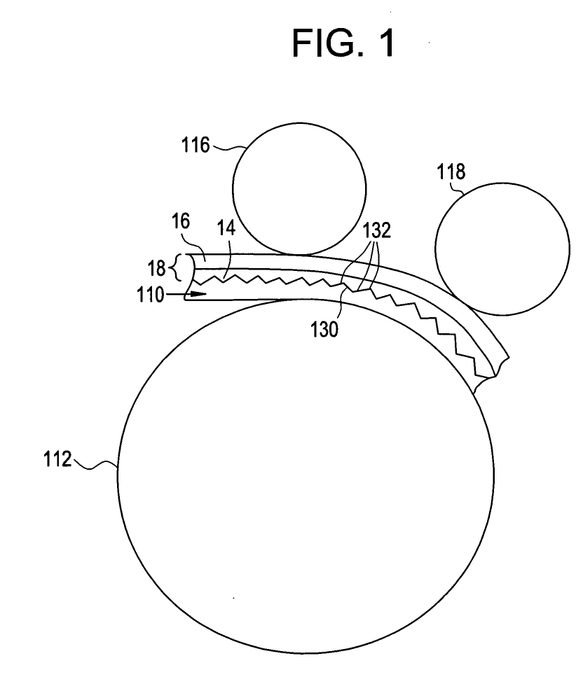

Referring to FIG. 1, layered film 18 comprises an imprinting layer 14 and a supportive layer 16. Layers 14 and 16 are permanently bonded together, either directly and/or with additional layer(s) therebetween and/or on a side of layer 16 opposite layer 14. In other words, both imprinting layer 14 and supportive layer 16 form at least part of an embossed multilayer film. Optionally, coating(s) can be applied to either or both of layers 14, 16, (and/or other layers disposed on a side of the supportive layer 16 opposite layer 14). However, no carrier layer (e.g., layer that is removed after embossing) is used during the embossing process. The imprinting layer 14 and the supportive layer 16 are not intentionally separated, i.e., supportive layer 16 is not a removable carrier layer, but is an integral part of the multilayer film.

Supportive layer 16 supports imprinting layer 14 during the embossing process. As a result, the material of supportive layer 16 has a higher glass transition temperature than the material of imprinting layer 14. During processing, supportive layer 14 is softened (e.g., heated above its glass transition temperature (T_{g})). Since layer 16 has a higher glass transition temperature (T_{g}) and/or higher melting temperature (Tₘ) than layer 14, layer 16 can maintain its structural integrity during the embossing of layer 14. Supportive layer 16 can comprise a material having a Tₘ and/or T_{g} that is sufficiently different than the Tₘ and/or T_{g} (respectively) of the layer 14 material such that, under the embossing conditions, layer 16 retains it structural integrity, and supports layer 14. For example, the Tₘ and/or T_{g} of the material of layer 16 can be greater than or equal to about 15° C. higher than the Tₘ and/or T_{g} (respectively) of the material of layer 14, or more specifically, greater than or equal to about 30° C. higher than the Tₘ and/or T_{g} (respectively) of the material of layer 14, or, yet more specifically, greater than or equal to about 45° C. higher than the Tₘ and/or T_{g} (respectively) of the material of layer 14.

Imprinting layer 14 can comprise any material that can be embossed and that provides the desired mechanical and optical properties. If imprinting layer 14 is not compatible with supportive layer 16 (e.g., will not sufficiently bond thereto to prevent delamination), layer(s) can be disposed between the imprinting layer 14 and the supportive layer 16 to attain the desired mechanical properties.

In one embodiment, the imprinting layer glass transition temperature is less than or equal to about 115° C. and the supportive layer glass transition temperature is about 135° C., or, more specifically, layer 14 has a glass transition temperature of less than or equal to about 105° C., while layer 16 has a glass transition temperature of greater than or equal to about 140° C. For example, the layer 14 comprises polycarbonate and polyester, or, more specifically, layer 14 comprises a polycarbonate-polyester copolymer such that layer 14 has a glass transition temperature of about 90° C. to about 105° C. (e.g., XYLEX®, commercially available from General Electric Plastics, Pittsfield, Mass.). Meanwhile, layer 16 comprises polycarbonate having a glass transition temperature of about 140° C. to about 150° C. (e.g., LEXAN®, commercially available from General Electric Plastics, Pittsfield, Mass.).

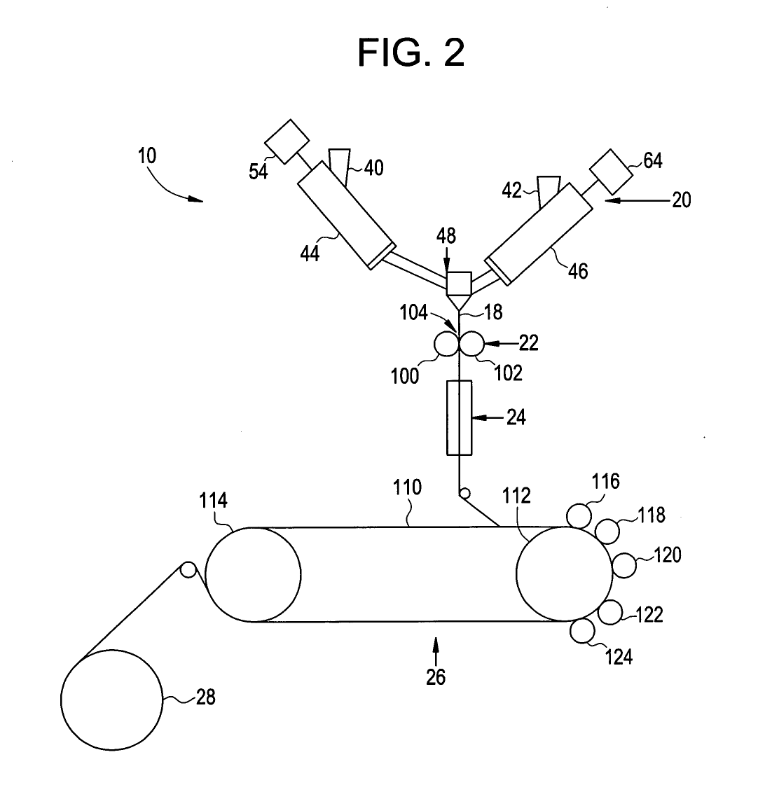

FIG. 2 is an exemplary embossing system 10 for producing embossed multilayer films 12 without the need for a carrier layer. The system 10 includes a co-extrusion device 20, a calendaring device 22, a film cooling station 24, an embossing station 26, and an uptake roller 28. The extrusion device 20 (e.g. co-extrusion device) has a first hopper 40, a second hopper 42, a first extruder 44, a second extruder 46, and a co-extrusion block 48.

First and second hoppers 40, 42 are provided to route plastic stock material to the extruder(s). Specifically, material forming imprinting layer 14 is fed into hopper 40, and material forming supportive layer 16 is fed into hopper 42. These hoppers can feed extruder(s) 44, 46, that feed co-extrusion die 48 that forms the layered film 18. In other embodiments, the layers 14, 16 can be separately formed, disposed adjacent to one another (with additional layer(s) optionally disposed therewith) to form the layered film 18, and then processed similar to the co-extrusion layers.

From the extrusion device 20, the layered film 18 passes through calendaring device 22, cooling station 24, and onto embossing belt 110. Calendaring device 22 can be employed to control the thickness of the layered film 18, and optionally to impart a desired surface finish to the surface of the layered film 18 (e.g., to the supportive layer 16). Calendaring device 22 comprises calendaring rollers 100 and 102 that form a nip 104 that can be maintained at a desired nip pressure. Layered film 18 is fed through the nip 104. The roller 102 can provide a surface finish such as a polish finish, a matte finish, or a velvet finish.

When the layered film 18 is routed through the nip 104, calendaring rollers 100 and 102 provide a selected pressure to the multilayer film to compress the film to a selected thickness. The thickness of the multilayer film and the imprinting and supportive layers can be selected for materials employed, processing requirements, and the end-use requirements. The thickness of the multilayer film can be about 0.025 millimeters (mm) to about 2 mm, or, more specifically, about 0.1 mm to about 1 mm, and still more specifically, about 0.15 mm to about 0.5 mm. The thickness of imprinting layer 14 can be sufficient to receive the desired surface features, e.g., thicker than the largest surface feature. The thickness of the supportive layer 16 is variable based upon the size of the imprinting layer, cost considerations, and so forth, and is sufficient to provide the desired structural integrity to the imprinting layer during processing. For example, the thickness can be greater than or equal to about 0.025 mm.

After being processed by the calendaring device 22, the layered film 18 can be routed to a cooling station 24 that can cool the layered film 18 to below the supportive layer glass transition temperature. The cooling station 24 can comprise a forced air cooling device (e.g., in which fans force cooled air over surface(s) of the layered film 18), liquid cooling device, other thermal exchanging devices, as well as combinations comprising at least one of the foregoing. Depending upon the process design, the layered film 18 can be cooled to a temperature below the supportive layer glass transition temperature yet above the imprinting layer glass transition temperature, or to a temperature below the imprinting layer glass transition temperature. If the supportive layer 16 is not coextruded with the other layer(s), depending upon the temperature of any extruded layer(s), the cooling station 24 may be eliminated from the system. Once below the glass transition temperature of layers 14, 16.

In an alternative exemplary embodiment, each layer 14, 16 can be separately formed into a sheet and then disposed adjacent to one another to form a layered film with other optional layer(s) therebetween possible. Layers 14, 16 can be attached together (e.g., laminated) before or during the embossing process. For example, can be aligned together prior to the embossing process by routing the imprinting and supportive layers through a roll lamination device. The roll lamination device can heat one or both of the layers 14, 16 to above their glass transition temperature, and can apply a pressure to join the layers 14, 16. The supportive layer can then be cooled to enable it to provide the desired structural integrity to the imprinting layer during embossing.

Optionally, the multilayer film can be preheated with heater(s) prior to contacting the belt and/or prior to contacting the roller 116. Once at the desired thermal condition (e.g., the imprinting layer is heated to an imprinting layer temperature that enables the desired imprinting), the layered film 18 passes through the embossing station 26 which embosses surface structures into layer 14. The imprinting temperature can be greater than or equal to 10° C. lower than both the supportive layer melting temperature and the supportive layer glass transition temperature, or, more specifically, greater than or equal to 20° C. lower than both the supportive layer melting temperature and the supportive layer glass transition temperature.

In yet another embodiment, the supportive layer can be formed and introduced to a nip between calendaring rolls as the imprinting layer can be extruded into the nip to form the imprinting layer onto the supportive layer or can be a heated layer introduced to the nip on the supportive layer, and to imprint the desired surface features onto the supportive layer. Since the supportive layer has a higher Tₘ and/or T_{g} than the imprinting layer, it maintains its structural integrity, supports the imprinting layer during processing, and can have a desired surface texture on a side opposite the imprinting layer.

Embossing station 26 can include an embossing belt 110, a hot roller 112 (e.g. a heated roller), a cold roller 114 and compression rollers 116, 118, 120, 122, 124. Embossing belt 110 comprises the surface structures to be embossed into layer 14. This belt assists in heating and transporting the layered film 18. Embossing belt 110, a continuous belt disposed around the rollers 112 and 114, can be formed from a metal (e.g., nickel, iron, copper, cobalt, and so forth), and so forth, as well as combinations comprising at least one of the foregoing, such as martensitic, ferritic, and austenitic stainless materials, nickel titanium alloy, and the like. Embossing belt 110 has a surface 130 comprising an embossing pattern 132. For example, the embossing pattern 132 can be microstructures such as light-reflecting elements such as cube-corners (e.g., triangular pyramid), trihedral, hemispheres, prisms, ellipses, tetragonal, grooves, channels, microlenses, and others, as well as combinations comprising at least one of the foregoing.

The embossing belt 110 is disposed around rollers 112 and 114 and is operably coupled to the rollers 112, 114 such that the rollers induce embossing belt 110 to advance to various locations of embossing station 26 at a selected speed. The hot roller 112, which can be internally heated, can be capable of heating the embossing belt 110 and the imprinting layer 14 above the imprinting layer glass transition temperature and/or other heater(s) can be employed to attain the desired temperature, while the cold roller 114 is capable of cooling the multilayer film 12 to below the glass transition temperature of imprinting layer 14.

In addition to the rollers 14, 16, thermal exchange device(s) can be employed with the system. For example, additional heaters can be used before or during the embossing (e.g., before roll 112 or adjacent roll 112), and/or additional cooling device(s) can be employed after the compression roll 124.

Nips are formed between the heated roller 112 and compression rollers 116, 118, 120, 122, 124, enabling the provision of selected pressures to the multilayer film 18. The pressure forces the film, and especially the first surface 14, into the embossing belt 110, to emboss the microstructures into the imprinting layer 14. Rollers 116, 118, 120, 122, and 124, along with rollers 112, and 114 are manufactured from metals (e.g., copper, aluminum, iron), metal alloys (e.g., martensitic, ferritic, and austenitic stainless materials), as well as polymeric materials (e.g., ethylene propylene diamine monomer based rubber (EPDM), silicone). The external surface of the rollers can comprise a coating to enhance the properties of the roller (e.g., chromed, nitrided, nickel coated, polytetrafluoroethylene (PTFE) coated).

Compression rollers 116, 118, 120, 122, 124 are illustrated in FIG. 2 as disposed in an annular array, e.g., approximately 180 degrees around the hot roller 112. During operation, the compression rollers 116, 118, 120, 122, 124 contact a side of the layered film 18 opposite the imprinting layer 14, e.g., layer 16 of multilayer film 12. Each roller 116, 118, 120, 122, 124 applies a selected pressure to multilayer film 12 to force layer 14 (which is heated) into embossing pattern 132 to imprint the selected surface structure on layer 14 of multilayer film 12. The selected pressure is applied as the layered film passes through the nip. The selected pressure applied by each roller 116, 118, 120, 122, 124 can be adjusted by adjusting the gap height of the nip. During operation, each roller 116, 118, 120, 122, 124 can provide a pressure sufficient to force layer 14 into pattern 132. In one embodiment, each roller can provide a subsequently greater pressure to multilayer film 12 than the previous roller. By providing subsequently greater pressures to multilayer film 12, the rollers can imprint the surface structure such that the surface structure conforms to the pattern within a selected tolerance range. Specifically, each roller 116, 118, 120, 122, 124 can exert a force of about 10 to about 100 pounds per square inch (psi) on the film, or more specifically about 25 to about 90 psi, or still more specifically about 50 to about 80 psi.

In an alternative exemplary embodiment, the microstructures can be disposed on a calendaring roller (e.g., directly or on a sleeve around the roller). Here, the supportive layer 16 can be introduced to a nip between the calendaring rollers wherein the imprinting layer 14 is extruded into the nip such that the imprinting layer 14 is disposed on the calendering roll comprising the microstructures. Here, the supportive layer 16 would provide the support to the imprinting layer 14 as the imprinting layer 14 coats the supportive layer 16 and as the microstructures are formed into the imprinting layer 14 as it cools to below its glass transition temperature.

After the surface structures are formed in layer 14, the belt transports multilayer film 12 to cold roller 114, and optionally past a cooling station (not shown). Cold roller 114 removes heat from multilayer film 12. Multilayer film 12 is then transferred from cold roller 114 to an uptake roller 28. Multilayer film 12 can then be stored or can then be transported to another location for further processing.

Since multilayer film 12 is embossed without using a separate carrier film (e.g., polyester films such as those sold under the MYLAR®, manufactured by Dupont Corporation, Wilmington, Del.), there is no need to remove the separate carrier film from multilayer film 12. This simplifies the process, and reduces material and equipment costs. Also, since the carrier film is not stripped from the multilayer film, there is a reduction in damaged and scrapped multilayer films due to damage of the microstructures during stripping. Additionally, since the supportive layer 16 can be in direct contact with calendaring roll(s), a desired surface finish can be disposed and maintained on the surface of the supportive layer 16.

The present process enables the production of an embossed multilayer film without the use of a removable carrier layer. The supportive layer, which is a portion of the final multilayer film, has a melting temperature (Tₘ) and/or glass transition temperature (T_{g}) that is substantially higher than the Tm and/or Tg of the imprinting layer such that the supportive layer can provide structural integrity to the imprinting layer during imprinting of surface features into the imprinting layer. Due to this temperature difference, surface features and/or texture on the supportive layer can be maintained throughout the formation of the multilayer film. Hence, multilayer films that were produced using a carrier layer did not have surface features and/or texture on the film second side; the features were not retained through the imprinting process. This process eliminates the need for a carrier layer, eliminates damage caused by the separation of the carrier layer from the formed film, and enables two sided texturing and/or imprinting of a multilayer film.

Multilayer films produced with the present process can be employed various multilayer film applications. These films can be used in any application where the control and/or adjustment of light is desired (e.g., reflected, diffused, collimated, and so forth). Exemplary applications include displays (e.g., back lit displays), signs, labels, and so forth. The multilayer film can be formed as a diffusing film, collimating film, and/or polarizing film.

The terms “first,” “second,” and the like, herein do not denote any order, quantity, or importance, but rather are used to distinguish one element from another, and the terms “a” and “an” herein do not denote a limitation of quantity, but rather denote the presence of at least one of the referenced item. The term “combination” is intended to include, as applicable, mixtures, blends, reaction products, alloys, and the like. If ranges are disclosed, the endpoints of all ranges directed to the same component or property are inclusive and independently combinable (e.g., ranges of “up to about 25 wt. %, or, more specifically, about 5 wt. % to about 20 wt. %,” is inclusive of the endpoints and all intermediate values of the ranges of “about 5 wt. % to about 25 wt. %,” etc.). The modifier “about” used in connection with a quantity is inclusive of the stated value and has the meaning dictated by the context (e.g., includes the degree of error associated with measurement of the particular quantity).

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A process for forming a multilayer film, comprising:
disposing a supportive layer adjacent to an imprinting layer to form a multilayer film;
imprinting microstructures in the imprinting layer at an imprinting temperature as the multilayer film passes between a heated roller and a compression roller, wherein the multilayer film is free of a removable carrier layer; and
wherein the supportive layer has a supportive layer glass transition temperature that is greater than or equal to about 15° C. higher than the imprinting layer glass transition temperature and/or the supportive layer has a supportive layer melting temperature that is greater than or equal to about 15° C. higher than an imprinting layer melting temperature; and
wherein the imprinting temperature is lower than both the supportive layer melting temperature and the supportive layer glass transition temperature.

2. The process of claim 1, wherein disposing the supportive layer adjacent to the imprinting layer further comprises co-extruding the imprinting layer and the supportive layer to form the multilayer film.

3. The process of claim 2, further comprising
passing the co-extruded imprinting layer and supportive layer through a nip between calendering rolls;
cooling the co-extruded imprinting layer and supportive layer; and
disposing a texture on a second side of the supportive layer opposite the imprinting layer.

4. The process of claim 1, wherein disposing the supportive layer adjacent to the imprinting layer further comprises
forming the supportive layer with a desired surface texture on a second side;
forming the imprinting layer; and
disposing the imprinting layer adjacent to a first side of the supportive layer.

5. The process of claim 4, further comprising disposing a third layer between the imprinting layer and the supportive layer.

6. The process of claim 1, wherein the supportive layer glass transition temperature is greater than or equal to about 30° C. higher than the imprinting layer glass transition temperature.

7. The process of claim 6, wherein the supportive layer glass transition temperature is greater than or equal to about 45° C. higher than the imprinting layer glass transition temperature.

8. The process of claim 1, wherein the imprinting layer glass transition temperature is less than or equal to about 115° C. and the supportive layer glass transition temperature is about 135° C.

9. The process of claim 8, wherein the imprinting layer glass transition temperature is about 90° C. to about 105° C. and the supportive layer glass transition temperature is about 140° C. to about 150° C.

10. The process of claim 9, wherein the imprinting layer comprises polycarbonate-polyester copolymer, and wherein the supportive layer comprises polycarbonate.

11. The process of claim 1, wherein the supportive layer melting temperature is greater than or equal to about 30° C. higher than the imprinting layer melting temperature.

12. The process of claim 6, wherein the supportive layer melting temperature is greater than or equal to about 45° C. higher than the imprinting layer melting temperature.

13. The process of claim 1, wherein the supportive layer physically contacts the compression roller.

14. The process of claim 1, wherein the imprinting temperature is greater than or equal to 10° C. lower than both the supportive layer melting temperature and the supportive layer glass transition temperature.

15. The process of claim 14, wherein the imprinting temperature is greater than or equal to 20° C. lower than both the supportive layer melting temperature and the supportive layer glass transition temperature.

16. A process for forming a multilayer film, comprising:
heating an imprinting layer to an imprinting layer temperature; and
imprinting microstructures in the imprinting layer to form a multilayer film comprising the imprinting layer and a supportive layer;
wherein a supportive layer physically contacts the compression roller during processing and has a supportive layer glass transition temperature that is greater than or equal to about 15° C. higher than the imprinting layer glass transition temperature and/or the supportive layer has a supportive layer melting temperature that is greater than or equal to about 15° C. higher than an imprinting layer melting temperature.

17. The process of claim 16, wherein the imprinting temperature is greater than or equal to 20° C. lower than both the supportive layer melting temperature and the supportive layer glass transition temperature.

18. The process of claim 16, wherein during imprinting, the multilayer film consists of the imprinting layer, the supportive layer, and optionally a layer therebetween.
